(19) United States
(12) Patent Application Publication
(10) Pub. No.: US 2004/0013164 A1
(43) Pub. Date: Jan. 22, 2004

(54) Temperature monitoring apparatus with alarm capability

(76) Inventor: Chimg-Piao Li, Ping-Tung City (TW)

Correspondence Address: LOWE HAUPTMAN GILMAN & BERNER LLP, Suite 310, 1700 Diagonal Road, Alexandria, VA, 22314, US

(21) Appl. No.: 10/197,860

(22) Filed: Jul. 19, 2002

(51) Int. Cl. G01K 7/00

(52) U.S. Cl. 374/163; 374/208

(57) ABSTRACT

A temperature monitoring apparatus includes a monitoring device and an alarm device. The monitoring device includes a first thermal sensing unit adapted to be placed in contact with a target object for measuring temperature thereof, a user input unit for setting a predetermined temperature range, a processing unit to verify whether the temperature of the target object as measured by the first thermal sensing unit falls within the predetermined temperature range, a display unit for showing the predetermined temperature range and the temperature of the target object thereon, and a signal transmitting unit for transmitting an alarm enable signal when the temperature of the target object does not fall within the predetermined temperature range. The alarm device includes a signal receiving unit for receiving the alarm enable signal, and an alarming unit for generating an alarm output when the signal receiving unit receives the alarm enable signal.

### BACKGROUND OF THE INVENTION

1. Field of the Invention

The invention relates to a temperature monitoring apparatus, more particularly to a temperature monitoring apparatus with an alarm capability.

2. Description of the Related Art

Referring to FIG. 1, a conventional thermometer 1 is shown to comprise a thermal sensing unit 11 and a display unit 12. The thermal sensing unit 11 is placed in contact with a target object, such as under the armpit of a patient, for temperature measuring purposes. The display unit 12 is used to display the temperature measured by the thermal sensing unit 11.

FIG. 2 illustrates another conventional thermometer 2 that is suitable for frequent or continuous monitoring of body temperature. The thermometer 2 includes a processor unit 21 with a display panel 211, a contact pad 22 for contacting a target object so as to measure temperature thereof, a transmission line 23, and an alarm unit 24 for alarm generation. In use, the contact pad 22 is attached to the skin of a patient, and the measured temperature is send to the processor unit 21 via the transmission line 23. The processor unit 21 is capable of body temperature monitoring, provides the measured body temperature to the display panel 211 for display, and wirelessly transmits an alarm enable signal to the alarm unit 24 to enable the latter to generate an alarm output when the measured temperature does not fall within a predetermined temperature range.

Although the thermometer 2 facilitates frequent or continuous monitoring of the body temperature, there is still some room for improvement. Particularly, the thermometer 2 is not provided with a mechanism for varying the predetermined temperature range to suit the target object. It is known that different patient age groups have different normal body temperature ranges. For example, the normal body temperature range for infants is 37.5 to 38.5° C., for small children is 36.8 to 38° C., for adults is 36 to 37.5° C., etc. Different sets of thermometers 2 must thus be provided to be able to monitor the body temperatures of patients in the different age groups, thereby resulting in waste of resources and in the likelihood of error in use.

### SUMMARY OF THE INVENTION

Therefore, the main object of the present invention is to provide a temperature monitoring apparatus that can overcome the aforesaid drawback associated with the prior art.

Accordingly, the temperature monitoring apparatus of this invention comprises a monitoring device and an alarm device.

The monitoring device includes a first thermal sensing unit adapted to be placed in contact with a target object for measuring temperature thereof, a user input unit manually operable so as to set a predetermined temperature range, a processing unit connected to the user input unit and the first thermal sensing unit, and operable so as to verify whether the temperature of the target object as measured by the first thermal sensing unit falls within the predetermined temperature range that was set via the user input unit, a display unit connected to and controlled by the processing unit so as to show at least one of the predetermined temperature range and the temperature of the target object thereon, and a signal transmitting unit connected to and controlled by the processing unit so as to transmit an alarm enable signal when the temperature of the target object does not fall within the predetermined temperature range.

The alarm device includes a signal receiving unit for receiving the alarm enable signal transmitted by the signal transmitting unit, and an alarming unit connected to the signal receiving unit and enabled so as to generate an alarm output when the signal receiving unit receives the alarm enable signal.

### BRIEF DESCRIPTION OF THE DRAWINGS

Other features and advantages of the present invention will be come apparent in the following detailed description of the preferred embodiments with reference to the accompanying drawings, of which:

FIG. 1 is a perspective view showing a conventional thermometer;

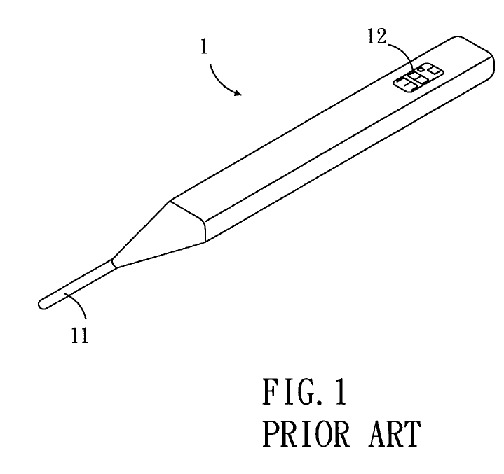

FIG. 2 is a perspective view showing another conventional thermometer with an alarm capability;

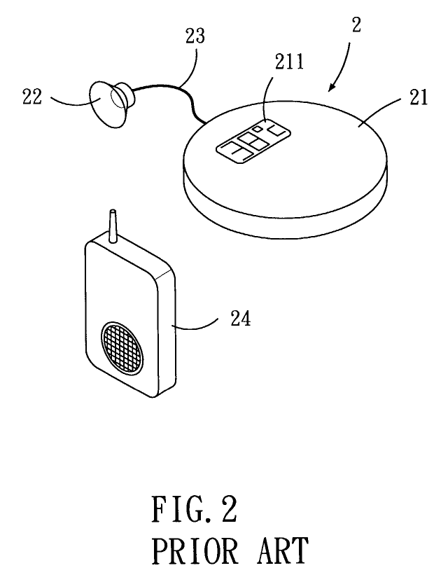

FIG. 3 is a perspective view of the first preferred embodiment of a temperature monitoring apparatus according to the present invention;

FIG. 4 is a schematic circuit block diagram of the first preferred embodiment;

FIG. 5 is a perspective view of the second preferred embodiment of a temperature monitoring apparatus according to the present invention; and

FIG. 6 is a schematic circuit block diagram of the second preferred embodiment.

### DETAILED DESCRIPTION OF THE PREFERRED EMBODIMENTS

Before the present invention is described in greater detail, it should be noted that like elements are denoted by the same reference numerals in the following detailed description of the preferred embodiments.

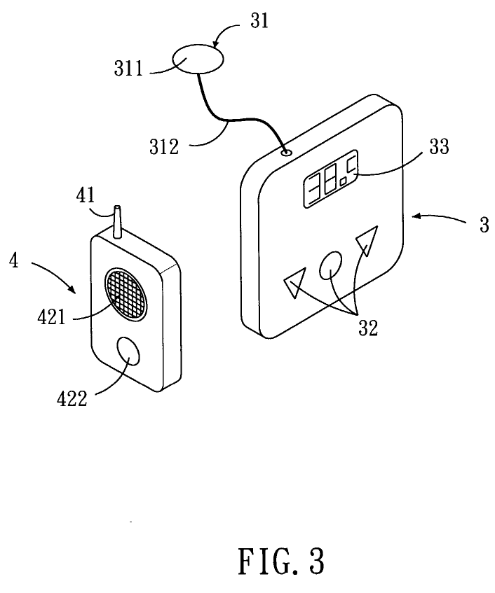

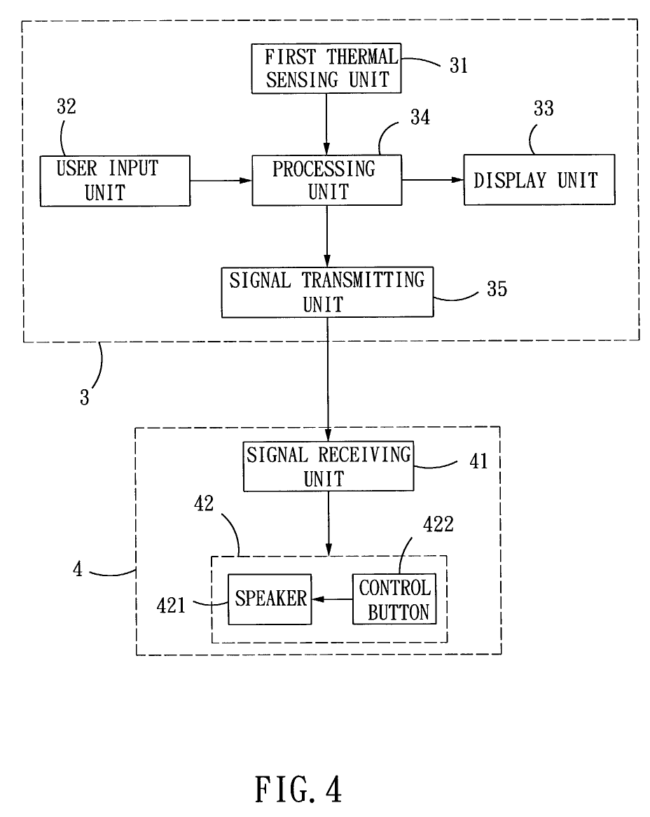

Referring to FIGS. 3 and 4, the first preferred embodiment of a temperature monitoring apparatus according to the present invention is shown to include a monitoring device 3 and an alarm device 4.

The monitoring device 3 includes a first thermal sensing unit 31, a user input unit 32,a processing unit 34 connected to the user input unit 32 and the first thermal sensing unit 31, a display unit 33 connected to and controlled by the processing unit 34, and a signal transmitting unit 35 connected to and controlled by the processing unit 34.

The first thermal sensing unit 31 includes a thermal sensing piece 311 adapted to be placed in contact with a target object for temperature measuring purposes, and a transmission line 312 for interconnecting the thermal sensing piece 311 and the processing unit 34.

The user input unit 32 includes a set of keys, and is manually operable so as to set a normal body temperature range and predetermined alarm times corresponding to times for giving medication.

The processing unit 34 receives the normal body temperature range and the predetermined alarm times from the user input unit 32, and the temperature measured by the first thermal sensing unit 31.

The display unit 33, in the form of a display panel, displays at least one of the predetermined temperature range, the temperature of the target object, and the predetermined alarm times.

The signal transmitting unit 35 is controlled by the processing unit 34 to transmit an alarm enable signal upon verification by the processing unit 34 that the temperature of the target object as measured by the first thermal sensing unit 31 does not fall within the normal body temperature range that was set via the user input unit 32 or upon verification by the processing unit 34 that a current time has reached one of the predetermined alarm times that were set via the user input unit 32.

The alarm device 4 includes a signal receiving unit 41 for receiving the alarm enable signal transmitted by the signal transmitting unit 35, and an alarming unit 42 connected to the signal receiving unit 41 and enabled so as to generate an alarm output when the signal receiving unit 41 receives the alarm enable signal. The alarming unit 42 includes a speaker 421 and a control button 422 to terminate activation of the speaker 421.

In use, the first thermal sensing unit 31 is positioned on a target object, for instance, beneath an armpit of an infant. Then, a desired monitoring body temperature range is inputted through the user input unit 32, e.g., 36.5 to 37.5° C. A plurality of alarm times, e.g. 12:00 AM, 6:00 PM, etc., corresponding to times for giving medication can be also optionally inputted through the user input unit 32. At this time, the display unit 33 will show the current measured body temperature of the infant. Through the control of the user input unit 32, the processing unit 34 can further control the display unit 33 to show the preset values, such as the temperature range and the alarm times, when desired. The processing unit 34 continuously verifies whether the current measured body temperature falls within the predetermined body temperature range and whether the current time has reached one of the predetermined alarm times. When the current measured body temperature does not fall within the predetermined body temperature range or when the current time has reached one of the predetermined alarm times, the processing unit 34 will control the signal transmitting unit 35 to transmit the alarm enable signal for reception by the alarm device 4. When the signal receiving unit 41 of the alarm device 4 receives the alarm enable signal, the speaker 421 of the alarming unit 42 will be enabled so as to generate an audible alarm output. The control button 422 can be operated to terminate activation of the speaker 421.

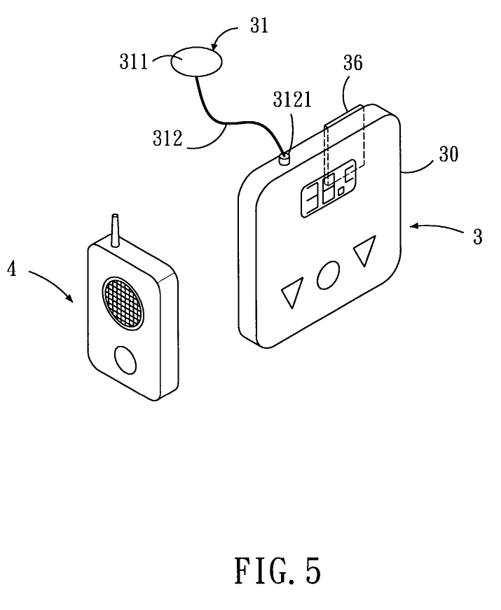

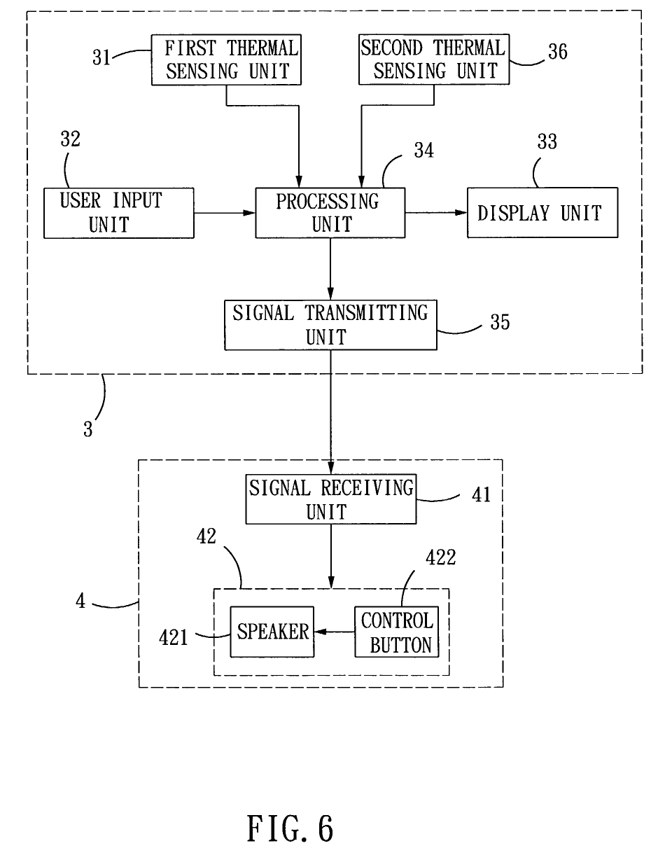

Referring to FIGS. 5 and 6, the second preferred embodiment of a temperature monitoring apparatus according to the present invention is shown to be similar to the previous embodiment, the main differences residing in that a second thermal sensing unit 36 is connected to the processing unit 34 and is adapted to measure ambient temperature, and that the transmission line 312 of the first thermal sensing unit 31 is detachably connected to the processing unit 34 via a connector 3121 on a housing 30 of the monitoring device 3. The processing unit 34 is configured so as to control the display unit 33 for showing the temperature of the target object thereon when the transmission line 312 of the first thermal sensing unit 31 is connected to the processing unit 34 and for showing the ambient temperature measured by the second thermal sensing unit 36 thereon when the transmission line 312 of the first thermal sensing unit 31 is disconnected from the processing unit 34.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A temperature monitoring apparatus comprising:
a monitoring device including
a first thermal sensing unit adapted to be placed in contact with a target object for measuring temperature thereof,
a user input unit manually operable so as to set a predetermined temperature range,
a processing unit connected to said user input unit and said first thermal sensing unit, and operable so as to verify whether the temperature of the target object as measured by said first thermal sensing unit falls within the predetermined temperature range that was set via said user input unit,
a display unit connected to and controlled by said processing unit so as to show at least one of the predetermined temperature range and the temperature of the target object thereon, and
a signal transmitting unit connected to and controlled by said processing unit so as to transmit an alarm enable signal when the temperature of the target object does not fall within the predetermined temperature range; and
an alarm device including
a signal receiving unit for receiving the alarm enable signal transmitted by said signal transmitting unit, and
an alarming unit connected to said signal receiving unit and enabled so as to generate an alarm output when said signal receiving unit receives the alarm enable signal.

2. The temperature monitoring apparatus as claimed in claim 1, wherein said monitoring device further includes a second thermal sensing unit connected to said processing unit and adapted to measure ambient temperature.

3. The temperature monitoring apparatus as claimed in claim 2, wherein said first thermal sensing unit includes a transmission line detachably connected to said processing unit, said processing unit being configured so as to control said display unit for showing the temperature of the target object thereon when said transmission line of said first thermal sensing unit is connected to said processing unit and for showing the ambient temperature measured by said second thermal sensing unit thereon when said transmission line of said first thermal sensing unit is disconnected from said processing unit.

4. The temperature monitoring apparatus as claimed in claim 1, wherein:
said user input unit is further manually operable so as to set a predetermined alarm time;
said processing unit being further operable so as to verify whether a current time has reached the predetermined alarm time;
said display unit being further controlled by said processing unit so as to show the predetermined alarm time thereon;
said signal transmitting unit being further controlled by said processing unit so as to transmit the alarm enable signal when the current time reaches the predetermined alarm time.

5. The temperature monitoring apparatus as claimed in claim 1, wherein said alarming unit includes a speaker.
